(19) United States
(12) Patent Application Publication
(10) Pub. No.: US 2013/0059157 A1
(43) Pub. Date: Mar. 7, 2013

(54) TRANSPARENT LAMINATES COMPRISING INTERMEDIATE OR ANOMALOUS GLASS

(71) Applicants: Dana Craig Bookbinder, Corning, NY (US); Timothy Michael Gross, Waverly, NY (US)

(72) Inventors: Dana Craig Bookbinder, Corning, NY (US); Timothy Michael Gross, Waverly, NY (US)

(21) Appl. No.: 13/640,153

(22) PCT Filed: May 25, 2011
(86) PCT No.: PCT/US2011/037885

§ 371 Date: Oct. 9, 2012

Related U.S. Application Data
(60) Provisional application No. 61/349,265, filed on May 28, 2010.

(51) Int. Cl. B32B 17/06

(52) U.S. Cl. 428/412; 428/428

(57) ABSTRACT

This disclosure is directed to laminates for transparent armor application and in particular to laminates comprising at least one layer of an intermediate or anomalous glass. Anomalous glasses include glasses with a SiO₂ content (in mol %) greater than 80 mol %, and the glasses can contain other elements that give the glass highly desirable properties such as impact resistance. Examples include Corning ULE glass 4 wt % to <20 wt % TiO₂ with the remainder being SiO₂, fused silica, and Vycor. An additional type of glass that can be used in the laminates described herein are “intermediate” glasses; for example, an aluminoborosilicate impact resistant glass comprising 60-72 mol % SiO₂; 9-16 mol % Al₂O₃; 5-12 mol % B₂O₃; 8-16 mol % Na₂O; and 0-4 mol % K₂O that is ion exchanged with potassium ions to form a chemically strengthened glass.

### CROSS-REFERENCE TO RELATED APPLICATIONS

This application claims the benefit of priority under 35 U.S.C. §119(e) of U.S. Provisional Application Ser. No. 61/349,265 filed on May 28, 2010 the content of which is relied upon and incorporated herein by reference in its entirety.

### FIELD

This disclosure is directed to laminates for transparent armor application and in particular to laminates comprising at least one layer of an intermediate or anomalous glass

### BACKGROUND

Transparent armor (“TA”) is used mainly for military vehicle windows, but it also having applications such as for windows in high security buildings or to protect against debris from severe storms such as tornados. TA is usually made using a laminate of float glass and impact resistant plastics such as polycarbonate. The glass and polymer materials are usually in the form of thin sheets (layers) that these are laminated together using transparent adhesive sheets of PVB (polyvinyl butyral) or PU (polyurethane), frequently referred to as the “interlayer.” between the glass and polymer material layers followed by a high-temperature and high-pressure bonding process step that is carried out in an industrial autoclave system. The composite material or laminate, after the autoclave process, appears optically monolithic with no visible bubbles or other defects. Depending on the threat level for which the armor is designed, the laminate can range in thickness from ½ inch to more than 5 inches. Because current military vehicles face increasingly high levels of threat, these glass-only armor systems often need to be as thick as 4-6 inches, and the weight of these thick, glass-only TA systems over-burdens the vehicles. Consequently, there is a strong need to use more advanced materials in order to reduce TA armor weight and thickness by providing less weights laminates that afford the same protection level or improved protection.

Researchers and engineers have studied different classes of transparent materials with the aim of delivering lighter weight transparent armor. Fully crystalline, transparent materials include sapphire, spinel and ALON (aluminum oxynitride). These ceramic materials can provide very high hardness and fracture resistance but are very expensive. While these materials work very well for armor piercing projectiles, providing >50% weight savings in stopping single shots over glass, they do not perform particularly well against fragment simulating projectiles, thus making armor system-level weight savings less than 50% when the requirements include both AP (anti-personnel) rounds and FSPs (fragmented simulated projectiles). The present disclosure is directed to other, less expensive methods of improving the performance of transparent armor laminates with regard both anti-personnel and fragmented simulated projectiles.

### SUMMARY

The disclosure relates to multi-layered laminate structures consisting of anomalous or crack and scratch resistant (“CSR”) glass in at least one layer. These laminate structures resist damage from impact events. Anomalous glass, such as SiO₂ has been shown to form wide angle cone cracks upon blunt impact (M. M. Chaudhri et al., J. Am. Ceram Soc. Vol. 69 (1986), page 404-410). The tendency of anomalous glass to form wide cone cracks even under high speed blunt impacts is advantageous over other glass systems since the crack is oriented away form the maximum flexural tensile stress of the panel; that is, the crack is oriented in a direction parallel to the surface that is impacted. The removal of water from anomalous glass has been shown to reduce the propensity for the glass to form cone cracks (T. M. Gross et al., J. Non. Cryst. Solids, Vol. 354 (2008), pages 5567-5569). Anomalous glass with low water content, or with deuterium substituted for hydrogen in water, will further enhance the performance of the glass. Anomalous glasses include glasses with a SiO₂ content (in mol %) greater than 80 mol %, and the glasses can contain other elements that give the glass highly desirable properties, for example, impact resistance, for transparent armor applications. Examples include Corning ULE glass (ultra-low expansion silica-titania glass containing 4 wt % to <20 wt % TiO₂), fused silica, and Vycor (a 96 wt % SiO₂ class containing 3 wt % B₂O₂, 0.4 wt % Na₂O and <1 wt % R₂O₃+RO₂ (where R is substantially Al₂O₃ and ZrO₂)). An additional type of glass that can be used in the laminates described herein are “intermediate” glasses; for example without limitation, an aluminoborosilicate impact resistant glass comprising 60-72 mol % SiO₂; 9-16 mol % Al₂O₃; 5-12 mol % B₂O₃; 8-16 mol % Na₂O; and 0-4 mol % K₂O that is ion-exchanged with potassium ions to form a chemically strengthened glass. The different glasses can impart different properties to the glass. For example, Corning ULE glass is expected to have a wider cone crack angle than SiO₂ following blunt impact, consequently stresses will be distributed over a larger area. It has also been demonstrated that crack and scratch resistant glasses, for example, the ion-exchanged aluminoborosilicate glass described above, are also highly resistant to damage from impacts. When used as part of a laminate structure, both anomalous and crack-and-scratch resistant (“CSR”) glasses will have significant advantages over other glass in terms of resistance to damage by impact.

The disclosure is further directed to a transparent armor laminate comprising a strike face, a spall catcher and one or a plurality of intermediate layers between the strike face and the spall catcher; the strike face being selected from the group consisting of anomalous glasses and intermediate glasses, the spall catcher being a polymeric material, and the one or plurality of intermediate layers being selected from the group consisting of sold-lime glass and glass-ceramics; and the layers of the laminate are adhesively bonded to one another. The strike face is an anomalous glass that is greater than 80% silica and is selected from the group consisting of silica glass, titania doped silica glass, fluorine doped silica glass, chlorine doped silica glass and deuterium doped silica glass. The intermediate layers are an aluminoborosilicate glass comprising 60-72 mol % SiO₂; 9-16 mol % Al₂O₃; 5-12 mol % B₂O₃; 8-16 mol % Na₂O; and 0-4 mol % K₂O that is then ion-exchanged with potassium ions to form a chemically strengthened glass. The intermediate aluminoborosilicate glass layers have a Young's modulus less than 64 GPa and a molar volume greater than 28 cm³/mol. The silica-titania anomalous glass i consists essentially of 6 wt % to <20 wt % TiO₂ and >80-94 wt % SiO₂ and a CET of less than +0.5×10⁻⁷/° C. at a temperature in the range of 5-35° C. In one embodiment the silica-titania glass consisting essentially of 7-15 wt % TiO₂ and 85-94 wt % SiO₂ and has a CET of less than −1.0×10⁻⁷/° C. at a temperature in the range of 5-35° C. In another embodiment the anomalous glass is a silica glass having less than 200 ppm OH. In a further embodiment the anomalous glass is selected from the group consisting of fluorine, chlorine and deuterium doped silica glass, the fluorine or chlorine dopant being up to 1000 ppm and the deuterium dopant being up to 500 ppm. In an additional embodiment the strike face is an intermediate glass of composition 60-72 mol % SiO₂; 9-16 mol % Al₂O₃; 5-12 mol % B₂O₃; 8-16 mol % Na₂O; and 0-4 mol % K₂O. The spall catch is a polymeric material selected from the group consisting of polycarbonate, and acrylic and methacrylic polymers.

### BRIEF DESCRIPTION OF THE DRAWINGS

FIG. 1 is a schematic diagram of the formation of a cone crack under dynamic conditions in an anomalous glass.

FIG. 2 is a schematic diagram of an anomalous glass that has a wider cone crack than that of FIG. 1.

FIG. 3 is a schematic diagram of the crack formed in normal glasses such as soda-lime glass under dynamic conditions as a result of highly strength limiting flaws present in the glass.

FIG. 4a is a photograph illustrating the suppression of crack formation under dynamic conditions in low water content (50 ppm) anomalous silica glass.

FIG. 4b is a photograph illustrating the high crack formation in anomalous silica glass having a water content of 900 ppm tested under the same conditions as the glass in FIG. 4a.

FIG. 5a is a photograph of a 1 kgf indentation in a crack and scratch resistant glass as viewed from the surface of the glass.

FIG. 5b is a photograph of the cross-section of the glass in FIG. 5a illustrating that deformation occurs by densification, thus making cracking more difficult.

FIG. 6 is a graph illustrating the linear dependence of CTE of a SiO₂—TiO₂ anomalous glass as a function to TiO₂ content showing that the glass can range from positive to zero to negative expansion.

FIG. 7 illustrates a projectile 18 impacting an exemplary armor laminate 10 having a strike face 12, one or a plurality of intermediate layers 14 and a spall catcher layer 18.

### DETAILED DESCRIPTION

The laminate system disclosed herein is useful for transparent armor applications and other applications where protection from flying debris is desired, for example without limitation, building windows. This herein all the glasses, glass-ceramics materials, spall catcher materials, interlayer materials and any other material that is used in the making of the laminates disclosed herein are transparent in the resulting laminate. The term “intermediate glasses” as used herein means a glass that has a low percentage of non-bridging oxygen atoms or substantially no non-bridging oxygen atoms, and additional has a Young's modulus of less than 64 GPa and a molar volume greater than 28 cm³/mol. The intermediate glasses typically contain 60-80 wt % SiO and selected other components, for example, boron, aluminum, zirconium, sodium and potassium. The intermediate glasses can be chemically strengthened by ion-exchange to create a compressive surfaces and a tensile stress between the surfaces.

There are a number of articles in the materials science literature concerning the structure and properties of so-called “normal” and “anomalous” glasses. Normal and anomalous glasses behave differently in many of their thermal and mechanical properties, and a number of studies have been done on static deformation and fracture properties of these glasses (see A. Arora et al, “Indentation deformation/fracture of normal and anomalous glasses,” J. Non-Cryst. Sol. 31 (1979), pages 415-428, and Z. Burghard, et al., “Crack opening profiles of indentation cracks in normal and anomalous glasses,” Acta Mater. 52 (2004), pages 293-297). Glasses such as soda lime (window) glass contain significant amounts of network modifiers, such as alkali and alkaline earth cations, and non-bridging oxygen atoms, and these types of glasses are known as “normal” glasses. On the other hand, anomalous glasses have few network modifiers or non-bridging oxygen atoms, and their strong tetrahedral networks therefore dominate the structure. Examples of anomalous glasses include silica and germania glass as well as borosilicate glasses, and glass ceramics such as Corning Code 9665 glass-ceramic wherein the continuous glassy phase is highly siliceous.

Two types of plastic deformation—shear flow and densification—are possible in glass (M. Bertoldi and V. M. Sglavo, “Soda-borosilicate glass: normal or anomalous behavior under Vickers indentation,” J. Non-Cryst. Sol. 344 (2004), pages 51-59), and normal and anomalous glasses have been shown to react differently in their deformation:
Shear flow is plastic flow that generates changes in body shape but not a volume change. Shear flow occurs via the breaking of bonds, and since bonds to non-bridging oxygen atoms are weaker than Si—O—Si bonds, normal glasses mainly display this kind of deformation.
Densification, on the other hand, is based on the compaction of a structure and resultant volume reduction. In general, no breakage of bonds is involved; rather, the bond angles between silica tetrahedra change and the tetrahedra rotate causing compaction/densification in the structure.
   Anomalous glasses chiefly undergo densification/deformation. High pressure (>10 GPa) experiments with silica glass have demonstrated a semi-permanent density increase of 20%. Modeling simulations suggest that some of the densification under high pressure may involve broken bonds, whereby Si coordination increases from 4 to 6. (See R. G. Della Valle and E. Venuti, High-pressure densification of silica glass: A molecular-dynamics simulation. Phys. Rev. B 54 (1996) 3809-3816.)

While most of these studies describe deformation under quasi-static conditions, Chaudhri and Kurkjian (Impact of small steel spheres on the surfaces of “normal” and “anomalous” glasses. J. Amer. Ceram. Soc. 69 (1986), pages 404-410), used high-speed photography to follow the formation and growth of damage in various glasses impacted by 1-mm diameter steel balls at velocities of ˜150 msec. They showed that, as in quasi-static experiments, the modes of cracking differ between normal and anomalous glasses as does the amount of debris generated, with the least amount generated during impact of silica glass. This study involved very small projectiles and low velocities compared to actual ballistics studies. Nevertheless, their results support the thesis of different structure glasses reacting differently in their impact behavior. It is of interest to note that Sehgal and Ito, “Brittleness of glass,” J. Non-Cryst. Sol. 253 (1999) 126-13, noted that fused silica is also the most “brittle” glass, where brittleness is defined as the ratio of hardness to toughness. Of the types of glasses described in this disclosure, silica is the most brittle glass, followed by borosilicate and then soda lime. Brittleness values correlate well (inversely) with glass density. Thus, while many static property and low-impact velocity studies do not correlate with the results of actual ballistics experiments, the data summarized herein indicates that the ability to undergo densification appears to be a key reason for the improved ballistics resistance of high silica glasses over soda lime.

The disclosure is directed to a laminate system having at least one layer of an anomalous glass or “crack-and-scratch resistant” (“CSR”) glass. In one embodiment the laminate system has a strike face layer of an anomalous or CSR glass, a spall catcher layer and at least one glass or glass-ceramic layers between the strike face layer and the spall catching layer. The “at least one” layer between the strike face and spall catcher layers can be anomalous glass, CSR glass, a transparent class-ceramic, soda-lime glass and other transparent glasses and glass-ceramics such as are commonly used transparent armor or window applications for protection against projectiles or flying debris. The spall catching layer can be any material that is commonly used as a spall catcher; for example without limitation, polycarbonate plastic, acrylic and methacrylic plastics, and other materials as known in the art to be useful as spall catchers.

Anomalous glasses, that is, glasses containing greater than approximately 80 mol % SiO₂, are advantageous for use in transparent armor laminate because they form wide angle conical cracking systems even at high impact velocities. The wider the angle of the cone, the further away is the orientation of the cracks from the maximum tensile flexural stress of the impacted panel. Anomalous glasses that form wider cone cracks upon high speed blunt impact are expected to have the greatest benefit to the overall damage resistance of a laminate structure. Most typical normal glasses will tend to form crack systems perpendicular to the impact surface, that is, in the same direction as in impacting object, rather than forming cone cracks upon high speed impact. These are most readily acted upon by the flexural stress of the panel.

While anomalous are known, it has been found that the removal of water from anomalous glass will enhance the damage resistance; for example, eliminating water from the anomalous glass will suppress cone crack formation. The anomalous glasses used in accordance with the disclosure have a high silica content of 80 mol % or greater. In one embodiment the anomalous glass is low water content silica glass having a hydroxyl (“OH”) content of less than 200 ppm, or is a fluorinated, chlorinated or deuterated SiO₂, and each of said glasses will have a greater resistance to crack formation than higher water content (greater than 200 ppm) SiO₂ glass. The fluorine or chlorine content of the doped glass can be up to approximately 2000 ppm and the deuterium content 500 ppm. Additionally CSR glass has been shown to be highly resistant to damage and should increase the damage resistance of a laminate structure when used a part of the multi-layer structure. An exemplary CSR glass is an aluminoborosilicate impact resistant glass comprising 60-72 mol % SiO₂; 9-16 mol % Al₂O₃; 5-12 mol % B₂O₃; 8-16 mol % Na₂O; and 0-4 mol % K₂O. Preferably the aluminoborosilicate glass is ion-exchanged to create a compression layer in the surface(s) of the glass and a tensile layer within the glass. When an anomalous glass or CSR glass is used as at least one layer of a multi-layer laminate structure, the structure advantageously has increased damage resistance.

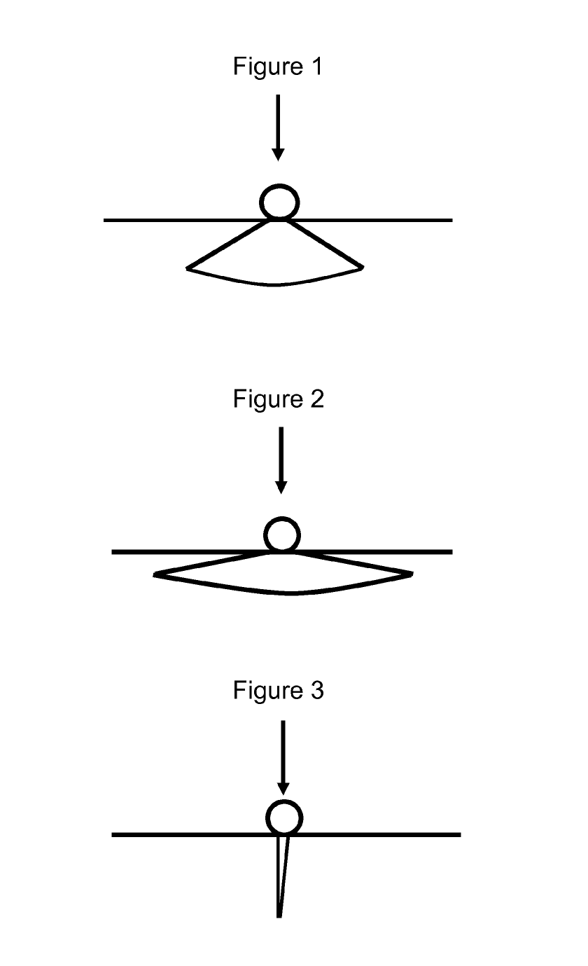

The disclosure in one embodiment is thus directed to the use anomalous glasses with high silica content (>80 mol %), or CSR glass as at least one layer in a multi-layered laminate structure. Anomalous glass has an advantage over other normal glasses due to its high propensity to form cone cracks as illustrated in FIGS. 1 and 2 rather median cracks as illustrated in FIG. 3. Median cracks are oriented perpendicular to the laminate surface as shown in FIG. 3 so that the flexural stress in the structure as a whole will cause a maximum in the crack opening stress at the crack tip. In contrast, since cone cracks are oriented away from the normal to the surface on the laminate structure as shown in FIGS. 1 and 2, they will experience less stress intensity at the crack tip during flexure of the panel. The wider cone cracks as illustrated in FIG. 2 will experience even less crack opening stress during the flexure of the laminate than those of FIG. 1. Glasses that form wider cone cracks, when used as a part of an armor laminate are expected to increase the performance of a laminate as a whole. Corning ULE® glass and other TiO₂—SiO₂ glasses containing up to, but not exceeding or equal to, approximately 20 wt % TiO₂, the remainder being SiO₂, are an examples of glasses expected to form wide cone cracks and have greater energy absorption under dynamic loading that is provided by anomalous SiO₂ only glass. In one embodiment the TiO₂ content is in the range of 6 wt % to <20 wt %. In another embodiment the TiO₂ content is in the range of 7-18 wt %. In an additional embodiment the TiO₂ content is in the range 7-15 wt % and the SiO₂ content is in the range of 85 wt % to 94 wt %.

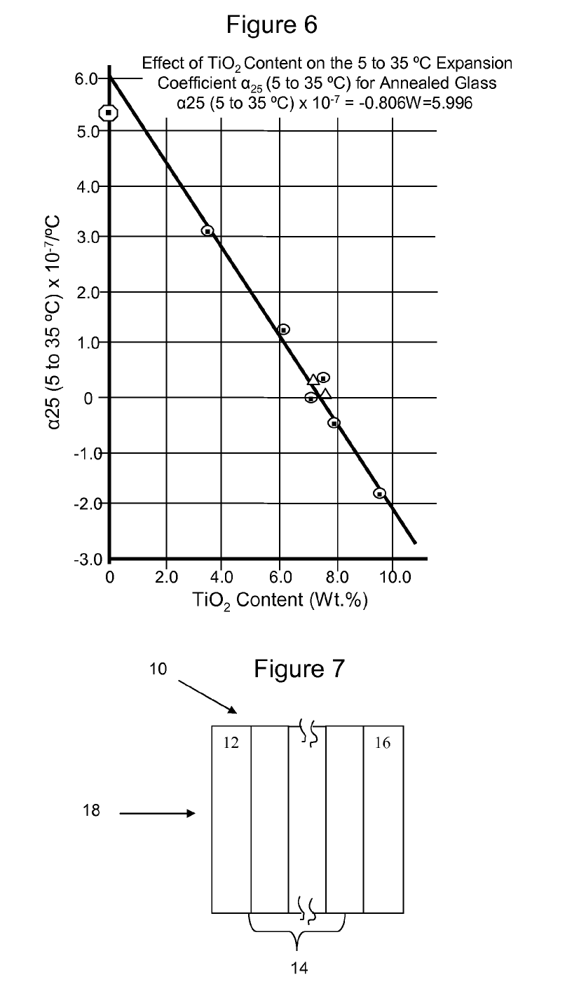

FIG. 6 is a graph illustrating the coefficient of thermal expansion (CTE) of SiO₂—TiO₂ anomalous glass as a function of TiO₂ content. The graph illustrates that some of these glasses have a negative CTE value. For example, as the TiO₂ content of the glass increases from approximately 7.5 wt % to approximately 11 wt %, the CTE decreases from approximately 0×10⁻⁷/° C. to approximately −3×10⁻⁷/° C., respectively. FIG. 6 indicates that increasing the TiO₂ content beyond 10-11 wt % will result in glasses that a greater negative expansion, for example, a CTE of in the range of −5×10⁻⁷/° C. to −10×10⁻⁷/° C., and that such glass will be more energy absorbing. An exemplary glass would be one containing 12 wt % to less than 20 wt % TiO₂, the remainder being silica.

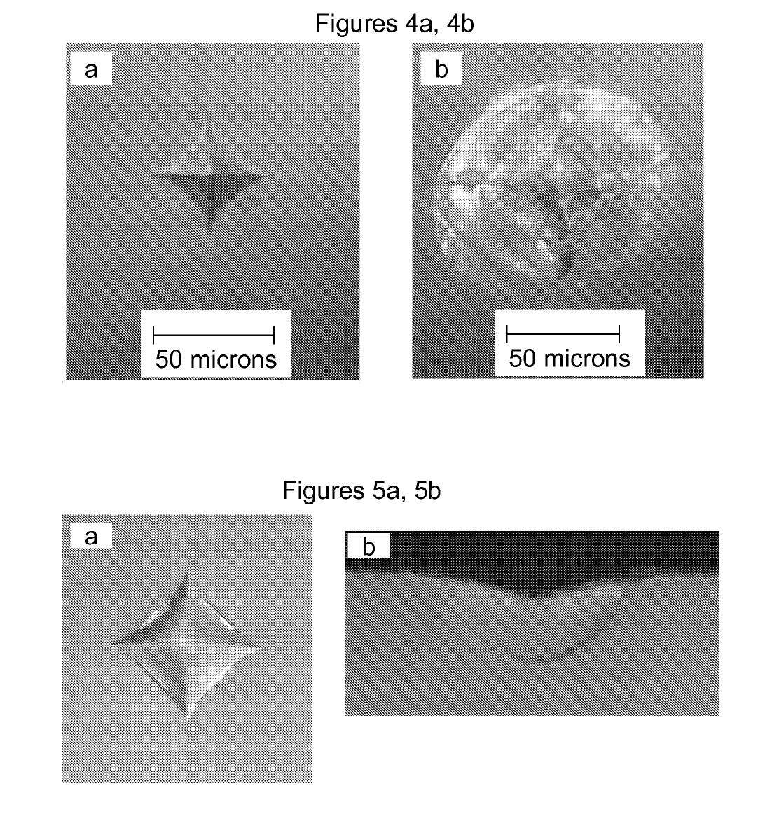

FIGS. 4a and 4b are photographs showing the results of indentation made in low (50 ppm) and high (900 ppm) water (hydroxyl) content SiO₂ glasses, respectively, under the same test conditions, this providing a direct comparison between high and low water SiO₂ glasses. The comparison of FIGS. 4a and 4b shows that reducing or eliminating the water content in an anomalous glass suppresses the formation of cone cracks when the glass is indented. It is reasonable to postulate that reducing the propensity to form flaws altogether will increase the impact loads required to initiate crack systems.

In addition to the silica glasses as described above (>80 mol % SiO₂, SiO₂—TiO₂ glass, and doped SiO₂ glasses, crack and scratch resistant (CSR) glasses also resist the formation of crack systems by a unique deformation mechanism. These CSR glasses, which can also be called “intermediate glasses,” are, for example without limitation, aluminoborosilicate glasses that have a low percentage of non-bridging oxygen atoms or substantially no non-bridging oxygen atoms. Additional characteristics of the intermediate glasses of any type, in addition to the low number of non-bridging oxygen atoms, are that they have a Young's modulus of less than 64 GPa and a molar volume greater than 28 cm³/mol. These intermediate (CSR) glasses deform primarily by densification and as a result are highly resistant to crack formation as is illustrated by FIGS. 5a and 5b. FIG. 5b is a cross-sectional view of CSR glass after indentation and it clearly shows that deformation in the intermediate glass primarily occurs by densification, and that this makes crack initiation more difficult.

Methods of making SiO₂, SiO₂—TiO₂ and “doped-SiO₂ (for example, Cl, F and D doped SiO₂) are known in the art and can be used prepare not only these glass but also other doped anomalous glasses. For example, SiCl₄ or an organosiloxane, for example, octamethyltetracyclosiloxane (OMTCS), can be combusted in a burner form a soot or powder that is deposited in a vessel or deposited on bait or mandrel as a perform and then consolidated into a glass. SiO₂—TiO₂ can be prepared by the combustion of a silica precursor and TiCl₄ or an organotitanium compound such as Ti(isopropoxide)₄. The soot or preform can be dehydrated at or near consolidation temperatures using, for example, chlorine, fluorine and CF₄ as dehydrating gases, preferably admixed with an inert glass, and then consolidated to form a low water content silica or doped silica glass. Deuterated glasses can be prepared by treating the glass with D₂ after consolidation to affect an exchange between the hydrogen in the glass and deuterium and thus form a deuterated surface. Alternatively, deuteration can be carried our after drying or during consolidation of the soot or preform.

FIG. 7 illustrates one embodiment of a projectile 18 impacting an exemplary armor laminate 10 according to the disclosure, the laminate having a strike face 12, one or a plurality of intermediate layers 14 and a spall catcher layer 18. Other embodiments are also possible—for example, a two layer laminate of an anomalous or CSR strike face layer and a spall catcher layer; a three layer laminate of an anomalous or CSR strike face layer, a spall catcher layer and an intermediate layer of a glass, glass-ceramic, anomalous glass or CSR glass between the strike face and spall catcher. Other possible combinations can also be made using the anomalous and CSR glasses as described herein,

It will be apparent to those skilled in the art that various modifications and variations can be made to the present disclosure without departing from the spirit and scope of the invention. Thus, it is intended that the present invention cover the modifications and variations of this disclosure provided they come within the scope of the appended claims and their equivalents.

We claim:

1. A transparent laminate comprising a strike face, a spall catcher and one or a plurality of intermediate layers between the strike face and the spall catcher;
the strike face being selected from the group consisting of anomalous glasses and intermediate glasses,
the spall catcher being a polymeric material, and
the one or plurality of intermediate layers being selected from the group consisting of sold-lime glass and glass-ceramics;
wherein the layers of the laminate are adhesively bonded to one another.

2. The laminate according to claim 1, wherein the strike face is anomalous glass that is greater than 80% silica and is selected from the group consisting of silica glass, titania doped silica glass, fluorine doped silica glass, chlorine doped silica glass and deuterium doped silica glass.

3. The laminate according to claim 1, wherein the intermediate layers are a aluminoborosilicate glass comprising 60-72 mol % SiO₂; 9-16 mol % Al₂O₃; 5-12 mol % B₂O₃; 8-16 mol % Na₂O; and 0-4 mol % K₂O that is then ion-exchanged with potassium ions to form a chemically strengthened glass.

4. The laminate according to claim 1, wherein the intermediate layers are an ion-exchanged aluminoborosilicate glass having a Young's modulus less than 64 GPa and a molar volume greater than 28 cm³/mol.

5. The laminate according to claim 1, wherein the anomalous glass is a silica-titania glass consisting essentially of 6 wt % to <20 wt % TiO₂ and 80-94 wt % SiO₂ and a CET of less than +0.5×10⁻⁷/° C. at a temperature in the range of 5-35° C.

6. The laminate according to claim 1, wherein the anomalous glass is a silica-titania glass consisting essentially of 7-15 wt % TiO₂ and 85-94 wt % SiO₂ and a CET of less than −1.0×10⁻⁷/° C. at a temperature in the range of 5-35° C.

7. The laminate according to claim 1, wherein the anomalous glass is a silica glass having less than 200 ppm OH.

8. The laminate according to claim 1, wherein the anomalous glass is selected from the group consisting of fluorine, chlorine and deuterium doped silica glass, the fluorine or chlorine dopant being up to 1000 ppm and the deuterium dopant being up to 500 ppm.

9. The laminate according to claim 1, wherein the strike face is an intermediate glass of composition 60-72 mol % SiO₂; 9-16 mol % Al₂O₃; 5-12 mol % B₂O₃; 8-16 mol % Na₂O; and 0-4 mol % K₂O.

10. The laminate according to claim 1, wherein the spall catch is selected from the group consisting of polycarbonate plastic, and acrylic and methacrylic plastics.
